(19) United States
(12) Patent Application Publication
(10) Pub. No.: US 2013/0062513 A1
(43) Pub. Date: Mar. 14, 2013

(54) SCANNING UNIT OF A POSITION MEASURING SYSTEM

(71) Applicants: Alexander Gruber, St. Georgen (DE); Jens Dormann, Nussdorf (DE); Mathias Schindler, Rohrdorf (DE)

(72) Inventors: Alexander Gruber, St. Georgen (DE); Jens Dormann, Nussdorf (DE); Mathias Schindler, Rohrdorf (DE)

(21) Appl. No.: 13/611,284

(22) Filed: Sep. 12, 2012

(30) Foreign Application Priority Data
Sep. 14, 2011 (DE) 10 2011 082 663.7

(51) Int. Cl. G01D 5/34; F21V 5/04; F21V 21/14

(52) U.S. Cl. 250/231.1; 362/418; 362/285

(57) ABSTRACT

A scanning unit that includes a radiation source that emits electromagnetic radiation, which is used to scan a scale of a position measuring system, wherein the radiation source includes electrical connection elements. The scanning unit further including a holder upon which the radiation source is fixable, wherein the holder includes electrical conductor elements that electrically contact the electrical connection elements. The electrical conductor elements of the holder and the electrical connection elements of the radiation source form a guide on which the radiation source is movable along an adjustment path relative to the holder while maintaining electrical contact between the electrical connection elements and the electrical conductor elements. Maintaining electrical contact enables positioning the radiation source at various positions along the adjustment path on the holder wherein the electrical connection elements are in electrical contact with the electrical conductor elements.

### RELATED APPLICATIONS

Applicants claim, under 35 U.S.C. §119, the benefit of priority of the filing date of Sep. 14, 2011 of a German patent application, copy attached, Serial Number 10 2011 082 663.7, filed on the aforementioned date, the entire contents of which is incorporated herein by reference.

### BACKGROUND

1. Technical Field

The present invention relates to a scanning unit of a position measuring system, such as a length measuring system. The present invention also relates to a position measuring system that uses a scanning unit and a method of adjusting a radiation source of a position measuring system.

2. Background Information

Such a scanning unit includes a radiation source for generating electromagnetic radiation, for instance in the form of a light-emitting diode (LED), by which a scale of the position measuring system, such as a scale having a graduation and extending (longitudinally) in a measuring direction, can be scanned. The radiation source is fixed on a holder that has electrical conductor elements for electrically contacting the radiation source. By fixation of the radiation source on the holder, the radiation source is, on the one hand, integrated with the scanning unit and fixed inside the scanning unit. On the other hand, the radiation source is connected electrically so that the radiation source can be supplied with current for generating electromagnetic radiation. To that end, the radiation source has electrical connection elements that are in electrical contact with the conductor elements of the holder when the radiation source is held by the holder.

Typically, such a scanning unit is embodied as a so-called scanning head, which by (photoelectric) scanning of an associated graduation of the position measuring system makes high-precision position determinations possible.

The graduation to be scanned can be provided, for instance, for forming a so-called length measuring system on a longitudinally extending scale. The scale can be provided for forming an angle measuring system by extending along a circular path on a graduated disk or on the inner or outer circumference of a drum. In addition, the graduation to be scanned by the scanning unit can be designed as either an incremental graduation or as an absolute code.

A position measuring device having a scanning unit of the type mentioned at the outset, in the form of a scanning head or sensor head, is known from German patent disclosure DE 198 43 155 A1. This scanning head or sensor head is embodied as an MID (molded interconnect device) with a holder in the form of a molded resin block, which is coated with a conductive film that has been structured in such a way that connecting lines that extend three-dimensionally over the block are created. An LED that serves the purpose of photoelectrically scanning a scale associated with the scanning head or sensor head is embodied in an opening in the block and is connected via electrical connection elements to connecting lines on one surface of the block.

The light emitted by such a radiation source, for instance in the form of an LED, is usually collimated by a lens and then passes as a parallel beam of light through a scanning plate before striking the graduation to be scanned. For precise collimation of the light emitted by the radiation source, the precise setting of the spacing between the radiation source and the lens used for collimation (collimator lens) is of importance.

### OBJECTS AND SUMMARY OF THE INVENTION

It is an object of the present invention to use a process or create a scanning unit of the type mentioned at the outset which by a simple design or process enables a defined positioning of the radiation source on the associated holder.

This object is attained according to the present invention by a scanning unit that includes a radiation source that emits electromagnetic radiation, which is used to scan a scale of a position measuring system, wherein the radiation source includes electrical connection elements. The scanning unit further including a holder upon which the radiation source is fixable, wherein the holder includes electrical conductor elements that electrically contact the electrical connection elements. The electrical conductor elements of the holder and the electrical connection elements of the radiation source form a guide on which the radiation source is movable along an adjustment path relative to the holder while maintaining electrical contact between the electrical connection elements and the electrical conductor elements. Maintaining electrical contact enables positioning the radiation source at various positions along the adjustment path on the holder, wherein the electrical connection elements are in electrical contact with each of the electrical conductor elements.

The above mentioned object is also attained according to the present invention by a position measuring system that includes a scale fastened to a first object and a scanning unit fastened to a second object, wherein the scale includes a graduation. The scanning unit includes a radiation source that emits electromagnetic radiation that scans the graduation, wherein the radiation source has electrical connection elements. The scanning unit further includes a holder upon which the radiation source is fixable, wherein the holder has electrical conductor elements that electrically contact the electrical connection elements. The position measuring system further includes a detector array that receives electromagnetic radiation from the scale and generates position-dependent signals from the received electromagnetic radiation. The electrical conductor elements of the holder and the electrical connection elements of the radiation source form a guide on which the radiation source is movable along an adjustment path relative to the holder while maintaining electrical contact between the electrical connection elements and the electrical conductor elements in order to enable positioning the radiation source at various positions along the adjustment path on the holder wherein the electrical connection elements are in electrical contact with the electrical conductor elements.

The above mentioned object is also attained according to the present invention by a method of adjusting a radiation source of a position measuring system, wherein the method includes providing a radiation source at a first position, wherein the radiation source emits electromagnetic radiation and includes electrical connection elements that electrically contact electrical conductor elements. The method further includes moving the radiation source at a second position, wherein during the moving the electrical connection elements move relative to the electrical conductor elements and maintain electrical contact with the electrical conductor elements during the moving.

Regarding the scanning unit, the conductor elements provided on the holder and the associated connection elements of the radiation source form a guide. Such a guide allows the radiation source to be movable relative to the holder along an adjustment path. Such relative movement occurs before fixation of the radiation source on the holder (and while maintaining the electrical contact between the radiation source and the conductor elements on the end toward the holder). Since the radiation source moves to various positions so there is electrical contact with the respective conductor elements of the holder, the radiation source can be supplied with current for generating light at the various positions.

As a result, the radiation source can be purposefully positioned on the holder in such a way that it has a defined spacing from an associated lens and/or scanning plate. In the position of the radiation source on the holder, the radiation source is electrically contacted and, thus, is immediately ready for operation as soon as it is fastened in the appropriate position.

The guidance of the radiation source along the adjustment path certainly does not necessarily need to be done solely by the guide formed by the conductor elements on the end toward the holder and the electrical connection elements on the end toward the radiation source. Alternatively, a guide device can be provided in a suitable receptacle on the holder. The guide device movably guides the radiation source along with its housing in a defined way along an adjustment path. In such a case, the (electrical) guide formed by the conductor elements and the connection elements can optionally be limited in its function to maintaining the electrical contact between the radiation source and the conductor elements on the end toward the holder during a movement (predetermined by the receptacle of the holder) of the radiation source along the adjustment path.

In one embodiment of the present invention, the guide formed by the conductor elements and the associated connection elements has at least one conductor track extending along the adjustment path and by an associated electrical contact element. The conductor elements and the associated connection elements are displaceable relative to one another along that adjustment path and in so doing are in electrical contact with one another. Such electrical contact enables electrical contact of the radiation source in various relative positions with regard to the holder. In particular, two conductor tracks, each of which is assigned a contact element, can be provided, since a radiation source typically has at least two electrical terminals.

In that case, the particular conductor track can be provided as an electrical conductor element on the holder, while the associated contact element is disposed as an electrical connection element on the radiation source.

The guide can be embodied for a rectilinearly guided movement of the radiation source by extending the at least one conductor element and/or the associated connection element rectilinearly.

The connection elements on the end toward the radiation source can be formed by contact pins protruding from the radiation source. Alternatively, the connection elements can extend along a housing of the radiation source.

Concrete embodiments of the conductor elements on the end toward the holder and the associated connection elements on the end toward the radiation source will be described hereinafter in conjunction with the drawings.

For the possible fixation of the radiation source on the holder in a plurality of different positions, especially suitable fastening methods are those with (nearly) arbitrary relative positions that are continuously variable or have small graduations, such as soldering, in particular laser soldering, adhesive bonding, or other materially joined connections. In each of the plurality of different positions, the radiation source is in electrical contact with the conductor elements on the end toward the holder.

The connection between the radiation source and the holder can be made either between the conductor elements on the end toward the holder and the associated electrical connection elements. Alternatively, the connection elements can be between the housing of the radiation source and an associated receptacle on the holder. In the first case, it is expedient to use electrically conductive connection means, such as an electrically conductive adhesive.

The scanning unit can in particular be embodied as a so-called MID (molded interconnect device), in that electrical conductor tracks, in particular in the form of a film applied to the base body of the holder, extend on a holder base body that includes electrical insulation material and serve the purpose of electrically contacting electrical components, such as the radiation source, that are disposed on the holder.

In MIDs, the plastic holder, made by injection molding, is for example selectively provided with electrical conductor elements. These conductor elements can be applied by known production processes, such as printing, hot stamping, LSA, laser direct structuring, and two-component injection molding methods.

If the conductor elements are deposited in currentless fashion on the holder, then in a further method the conductor elements can be reinforced by a galvanic deposition process.

Further details and advantages of the present invention will become apparent from the ensuing description of exemplary embodiments in conjunction with the drawings.

In the drawings:

### BRIEF DESCRIPTION OF THE DRAWINGS

FIG. 1A shows an embodiment of a length measuring system including a scale and a scanning head with a scanning unit in accordance with the present invention;

FIG. 1B shows a cross-section A-A of the length measuring system of FIG. 1A;

FIG. 2A shows an embodiment of a holder of the scanning unit of FIGS. 1A-B with conductor tracks for contacting electrical components that are to be disposed on the holder in accordance with the present invention;

FIG. 2B shows the holder of FIG. 2A together with an embodiment of a radiation source disposed thereon and electrically contacted in accordance with the present invention;

FIG. 3 shows a first modification of the holder of FIG. 2A to be used with the length measuring system of FIG. 1A in accordance with the present invention;

FIG. 4A shows a second modification of the holder of FIG. 2A to be used with the length measuring system of FIG. 1A in accordance with the present invention;

FIG. 4B shows the holder of FIG. 4A together with the radiation source of FIG. 2B disposed on the holder and electrically contacted in accordance with the present invention; and

FIG. 4C shows the scanning unit of FIG. 4B, disposed on a circuit board.

### DETAILED DESCRIPTION OF THE PREFERRED EMBODIMENTS

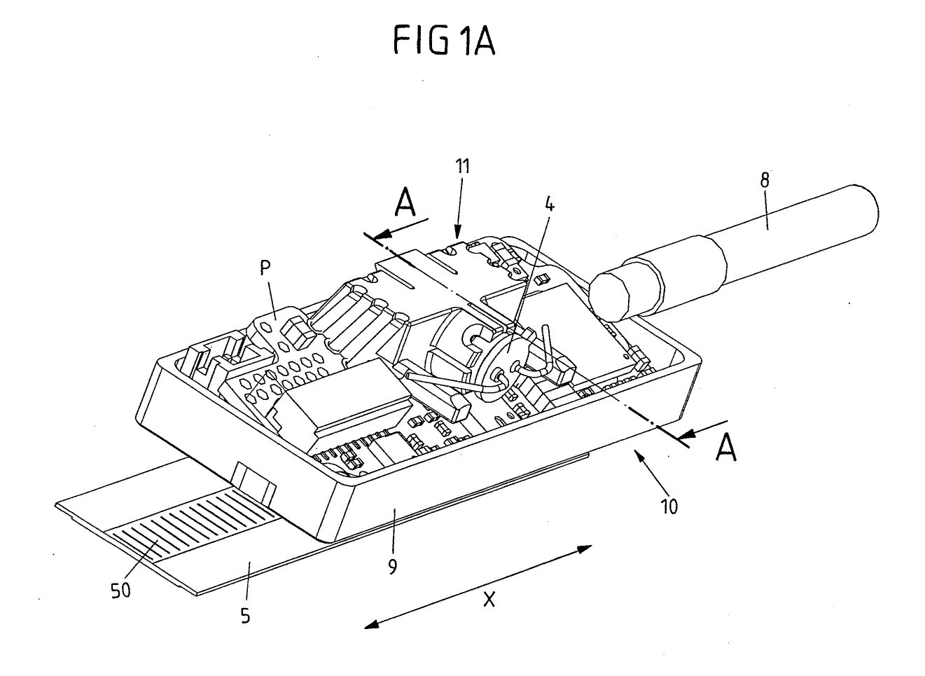

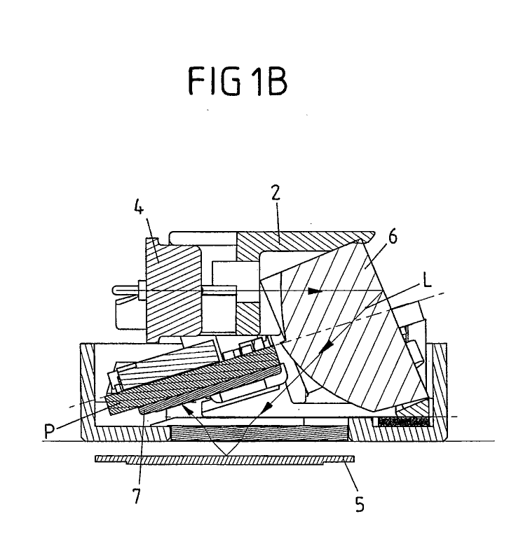

FIG. 1A shows a perspective view and FIG. 1B a cross-section A-A of a position measuring system in the form of a length measuring system, having a scanning head 10 and a graduation 50 of a scale 5 to be scanned by the scanning head 10. The length measuring system serves to measure the position in the measuring direction X of two objects to be measured which are movable relative to one another. The scanning head 10 is fastened to one of these objects to be measured, and the scale 5 is fastened to the other object. To better illustrate the makeup of the scanning head 10, only the lower part of the housing 9 is shown in FIG. 1A. The scanning head 10 has a scanning unit 11, which includes a holder 1 with a radiation source 4 that is positioned on the holder 1 and both mechanically fixed and contacted electrically. Advantageous details and possible embodiments of this scanning unit 11 will be described in further detail hereinafter in conjunction with the further FIGS. 2A-4C.

The radiation source 4 emits an electromagnetic radiation in the form of light radiation, with which the graduation 50 can be scanned. The path of a beam of light L is shown in FIG. 1B. The light emitted by the radiation source 4 in the position measurement operation reaches a lens 6, which shapes the beam of light, for instance collimates the beam of light, and aims the beam of light onward at the graduation 50. The beam of light L is modulated by the graduation 50 as a function of the relative location of the scanning head 10 and the scale 5 and finally the beam of light reaches a detector array 7 for generating position-dependent scanner signals. The electrical scanner signals can be transmitted to an electronic unit downstream via an electrical line 8 as shown in FIG. 1A.

Three different exemplary embodiments of a scanning unit 11 will now be shown in conjunction with FIGS. 2A-4C. These exemplary embodiments can serve to form the scanning head 10 schematically shown in FIGS. 1A and 1B. In particular, the embodiments can be used for those components of a scanning head 10 which serve to receive and supply current to the radiation source 4 and by which the electromagnetic radiation used for scanning the associated scale 5 is generated.

FIG. 2A shows a holder 1 of such a scanning unit. The holder includes a base body 2 having an electrical insulation material, such as plastic, on which a plurality of (electrically conductive) conductor elements in the form of (metal) conductor tracks 3 are mounted. The base body 2 may be provided with the conductor elements by a method known in MID technology, such as by coating the base body 2 with an electrically conductive film and optionally structuring the film. Examples of suitable materials for the conductor elements (conductor tracks 3) are copper, tin, lead, or gold.

The base body 2 of the holder 1 includes a holder region 20 from which a receptacle 22 that defines a receptacle chamber 23 for the radiation source 4—see FIG. 2B—protrudes. The receptacle 22 is embodied hollow-cylindrically and extends in a movement direction B, in which the associated radiation source 4 can be introduced into the receptacle 22. To that end, the radiation source 4 is provided with a substantially hollow-cylindrical housing 40—see FIG. 2B—so that it can be disposed inside the receptacle chamber 23 defined by the receptacle 22. Once inside the receptacle chamber 23, the radiation source 4 is movable in a movement direction B in the direction in which the receptacle 22 extends, which coincides with the cylinder axis. The movement direction B thus defines an adjustment path for possible movements of the radiation source 4 relative to the holder 1. The adjustment path can generally have either a rectilinear path (in at least some portions) or a curved path.

In a combined view of FIGS. 2A and 2B, the radiation source 4, in the form of an LED, is supported movably in the receptacle 22 of the holder 1 in a direction B that extends along the longitudinal axis of the hollow-cylindrical receptacle 22. As viewed in the movement direction B, the radiation source 4 can be disposed inside the receptacle 22, or inside the receptacle chamber 23 defined by it, in various positions, depending on the depth to which the radiation source 4 is introduced into the receptacle 22 or receptacle chamber 23.

Thus, the receptacle 22 forms a guide device for guiding the radiation source 4 as it is being introduced into the receptacle chamber 23. Also, the receptacle 22 forms a guide device upon a movement (displacement) of the radiation source 4 in the receptacle chamber 23 in order to dispose the radiation source 4 in the movement direction B in a defined position inside the receptacle chamber 23. The receptacle 22 is embodied in slit form in the exemplary embodiment, so that a plurality of portions (jaws) separated by slits are formed, which when the radiation source 4 is inserted exert a radial initial tension. When the radiation source 4 is inserted, the jaws exert a radial initial tension and (with as little play as possible) clamp and position the radiation source 4 radially, or, in other words, in directions perpendicular to the movement direction B.

The electrical contacting of the radiation source 4 on the holder 1 is made easier by the aforementioned MID technology, because conductor tracks 3, for instance in the form of film-like coatings, are provided on the base body 2. In the exemplary embodiment, they form terminal regions 32, by way of which the unit defined by the holder 1 and the radiation source 4 is electrically contactable to the conductor tracks of a circuit board P. The conductor tracks 3 of the holder 1 also form connection regions 34, 36 for electrically contacting the radiation source 4. In addition, the base body 2 of the holder 1 is an electrical insulation material, in particular plastic.

The conductor tracks that form these connection regions 34, 36 extend in the exemplary embodiment of FIGS. 1A and 1B on projections 24, 26 of the holder 1. As shown in FIGS. 2A-B, the projections 24, 26 extend on both sides of the receptacle 22, specifically in the movement direction B, in which the radiation source 4 can be introduced into the receptacle 22 and displaced inside the receptacle chamber 23.

For electrically contacting to the conductor tracks 3 of the holder 1, in particular to the connection regions 34, 36, provided for this purpose, of the conductor tracks 3, the radiation source 4 has connection elements 44, 46 serving as contact elements. In this exemplary embodiment, these connection elements 44, 46 protrude from the back side 42 of the housing 40 of the radiation source 4. In other words, the connection elements 44, 46 protrude from the back side 42 of the radiation source 4 that points away from the receptacle chamber 23 when the radiation source 4 is being introduced as intended into the receptacle 22.

The connection elements 44, 46 are embodied as (pin-like) contact pins, which are bent over or angled such that portions 44A, 46A of the connection elements 44, 46 intersect the connection regions 34, 36 of the conductor tracks 3 and in so doing rest on them. As a result, the connection regions 34, 36 of the conductor tracks 3 and the connection elements 44, 46 of the radiation source 4 form a guide. In the exemplary embodiment shown in FIGS. 2A-2B, the guide is a longitudinal guide, which permits displacement of the connection elements 44, 46 on the connection regions 34, 36 of the conductor tracks 3, while the connection elements 44, 46 are continuously in electrical contact with the conductor tracks 34, 36.

When the position of the radiation source 4 inside the receptacle 22 or receptacle chamber 23 is being set, the electrical contact between the radiation source and the conductor tracks 3 of the holder 1 can thus be maintained. Consequently, electrical contact between the radiation source 4 and the electrical circuits on the associated circuit board P can be maintained.

By moving or displacing the radiation source 4 inside the receptacle 22 of the holder 1, the position of the radiation source 4 in the receptacle chamber 23 can be set in such a way that certain predetermined spacings from further functional elements of the scanning unit are achieved. For example, a defined spacing of the radiation source 4 from an associated lens 6 or lens assembly (condenser lens), which serves to collimate the light emitted by the radiation source 4 during operation is achieved. In addition or alternatively, a certain spacing of the radiation source 4 from an associated scanning plate can also be set. The electrical contacting of the radiation source 4 via the connection elements 44, 46 and the connection regions 34, 36 (extending in the movement direction B) ensures that at every selected position of the radiation source 4, the desired electrical contact exists, so that the radiation source 4 can be supplied with electrical energy.

For fixing the radiation source 4 in a desired position inside the receptacle 22, a fixation of the electrical connection elements 44, 46 to the conductor tracks 3, or their connection regions 34, 36, can be effected. Such fixation can be accomplished by soldering, especially laser soldering, or by adhesive bonding (by an electrically conductive adhesive). Fundamentally, any connection methods can be used that enable fixing the connection elements 44, 46 on the connection regions 34, 36 of the conductor track 3 in as much as possible a continuously variable or finely graduated manner for this purpose.

In addition or alternatively, the radiation source 4 can be fixed in the receptacle 22 by fixing its housing 40 to the wall of the receptacle 22. To that end, fastening regions 22c, 22d in the form of recesses are provided in the wall of the receptacle 22 as shown in FIGS. 2A-B. In the exemplary embodiment, the edges of these recesses are coated with a metal material. Once again, various connection methods can be employed, again preferably connection methods that are as continuously variable as possible or that are finely graduated, such as soldering (laser soldering) or adhesive bonding as well as other materially joined connections.

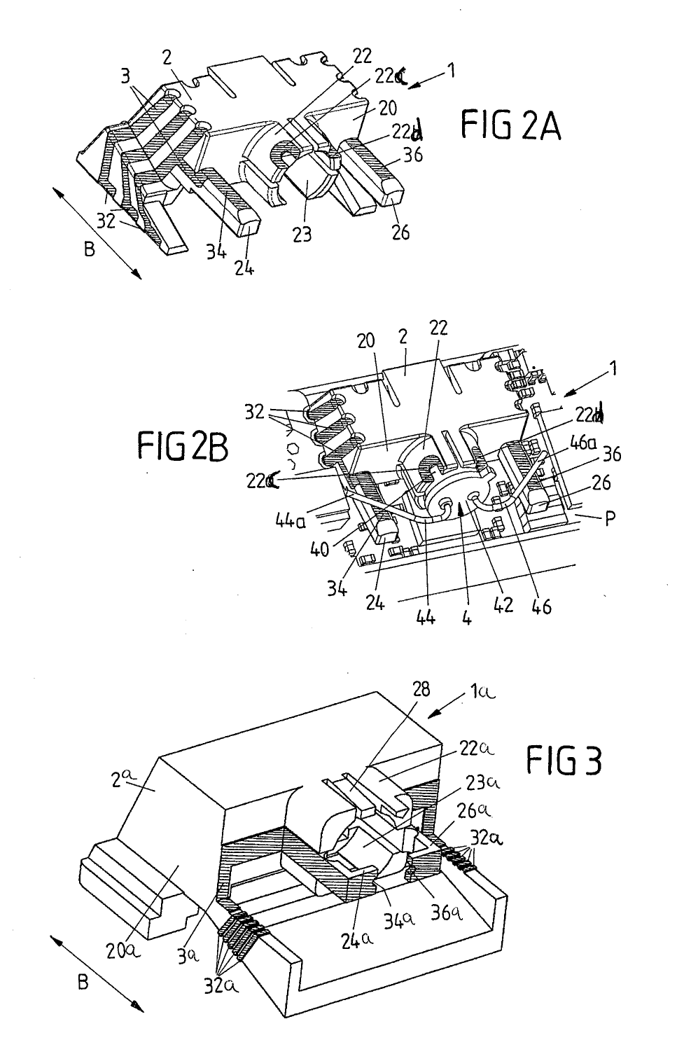

FIG. 3 shows a modification of the holder 1 of FIG. 2A. The holder 1a includes an electrically insulating base body 2a onto which conductor tracks 3a are applied. The conductor tracks 3a can be in the form of film-like coatings. The conductor tracks 3a form terminal regions 32a for electrically connecting the holder 1a to a circuit board. In addition, connection regions 34a, 36a are provided for electrically contacting conductor tracks of a radiation source that is disposed as intended inside the receptacle chamber 23a of a receptacle 22a of the holder 1a.

In the exemplary embodiment of FIG. 3, the receptacle 22a of the holder 1a again extends in a movement direction B, which coincides with an axis of the receptacle 22a. Along the axis a radiation source can be introduced into the receptacle 22a and moved (displaced) inside the receptacle chamber 23a.

In the exemplary embodiment of FIG. 3, the receptacle 22a is designed to be rectangular (for instance, essentially perpendicular to the movement direction B) in cross-section, with rounded corners. In the exemplary embodiment, the receptacle 22a also protrudes from a holder region 20a of the base body 2a, so that it extends in the movement direction B.

A further difference from the embodiment of FIG. 2A is that the connection regions 34a, 36a of the conductor tracks 3a of the holder 1a are disposed in front of the receptacle 22a. More precisely, the connection regions 34a, 36a are disposed in an imaginary extension of the receptacle chamber 23a in the movement direction B. The connection regions 34a, 36a of the conductor tracks 3a are concretely provided on projections 24a, 26a, which in terms of the movement direction B are located in front of the receptacle chamber 23a of the receptacle 22a.

For electrically contacting a radiation source 4—see FIG. 2B—the connection elements in the form of (pin-like) contact pins should protrude in this case essentially rectilinearly from the back side 42 of the housing 40 of the radiation source 4. When the radiation source 4 is disposed in the receptacle 22a of the holder 1a, the above mentioned contact pins rest on the connection regions 34a, 36a of the conductor tracks 3a in a manner as shown in FIG. 2B.

Unlike the arrangement in FIGS. 2A and 2B, in the exemplary embodiment of FIG. 3 the direction in which the guide formed by the connection regions 34a, 36a and the associated connection elements 44, 46 of the radiation source 4 extends is not predetermined primarily by how the connection regions 34a, 36a extend (as in the case of FIGS. 1A and 1B). Instead, the direction is determined by how the connection elements (contact pins) projecting from the radiation source 4 extend in the movement direction B.

In the present exemplary embodiment of FIG. 3, a part 28 of the receptacle 22a forms a portion (jaws/tab) that (by slits offset from adjoining regions of the receptacle 22a) is radially resilient. The portion exerts a radial pressure on the radiation source 4 and keeps the radiation source 4 positioned, with as little play as possible, in the receptacle 22a in directions perpendicular to the direction B during the guidance in the movement direction B.

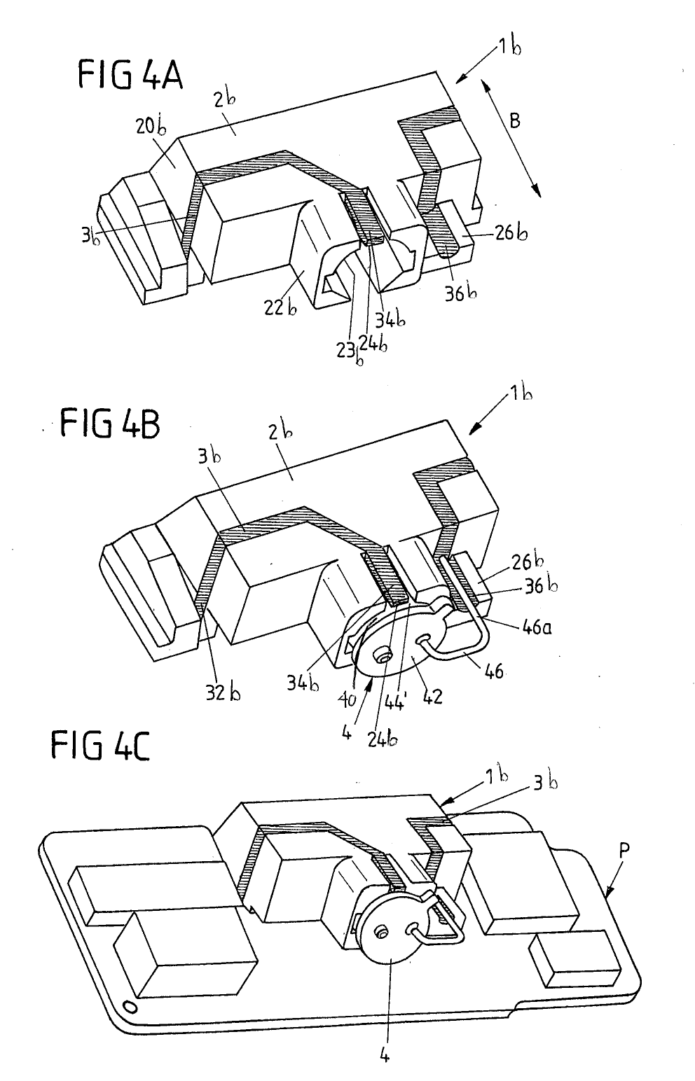

In FIGS. 4A-4C, a further exemplary embodiment of a holder 1b is shown. The holder 1b is provided with conductor tracks 3b. The electrically insulating base body 2b of the holder 1b defines a receptacle 22b, in which a radiation source 4 is disposed as shown in FIG. 4B. The unit defined by the holder 1b, the conductor tracks 3b, and the radiation source 4 is disposed on a circuit board P and as a result is integrated into an electrical or electronic circuit as shown in FIG. 4C.

In FIGS. 4A and 4B, the base body 2b of the holder 1b has a holder region 20, from which the receptacle 22b protrudes in a movement direction B. In the exemplary embodiment of FIGS. 4A and 4B, the receptacle 22b in cross-section is polygonal, with rounded corners. Once again, the receptacle 22b defines a receptacle chamber 23b inside which a radiation source 4 can be introduced in the movement direction B.

For electrically contacting the radiation source 4 and for electrically connecting the holder 1b to the circuit board B, conductor elements in the form of conductor tracks 3b are provided on the base body 2b. The conductor elements form terminal regions 32b for connection to conductor tracks on the circuit board. The conductor elements also form connection regions 34b, 36b for electrically contacting the radiation source 4.

Of the connection regions 34b, 36b of the conductor tracks 3b of the holder 1b, one connection region 34b extends along a wall region 24b of the receptacle 22b, and another connection region 36b extends on a projection 26b, which extends alongside the receptacle 22b, specifically in the movement direction B.

The purpose of electrically contacting the radiation source 4 to the two connection regions 34b, 36b, extending in the movement direction B, of the conductor tracks 3b on the end toward the holder 1b can be served, on the one hand, by a connection element 44′ located directly on the housing 40 of the radiation source 4, which given the disposition of the radiation source 4 inside the receptacle chamber 23b as intended is in electrical contact with the connection region 34b of the conductor tracks 3b that is integrated with the base body 2b, and on the other by a contact element 46 in the form of a pin-like connecting pin projecting from the radiation source 4, which pin is bent such that with a portion 46a, it extends along the associated connection region 36b of the conductor tracks 3b.

As in previous embodiments, the movement direction B is defined to be the direction in which the radiation source 4 can be introduced into the receptacle 22b and positioned inside the receptacle chamber 23b. Because the connection regions 34b, 36b of the conductor tracks 3b on the end toward the holder 1b extend in the movement direction B, electrical contact between the radiation source 4 and the connection regions 34b, 36b of the conductor tracks 3b on the end toward the holder 1b is permanently maintained during a movement or displacement of the radiation source 4 inside the receptacle 22b along movement direction B, with the goal of a defined positioning of the radiation source 4. The connection elements 44′, 46 on the end toward the radiation source 4 and the connection regions 34b, 36b on the end toward the conductor tracks 3b thus once again form a longitudinal guide.

As in the case of the exemplary embodiment of FIGS. 2A and 2B, a fixation of the radiation source 4 in a previously set position can also be effected as in the case of FIG. 3 and FIGS. 4A-4C by providing that the connection elements 44′, 46 of the radiation source 4 are fixed to the associated connection regions 34b, 36b of the conductor tracks 3b of the holder 1b. Such fixation, for instance, can be by soldering, especially laser soldering, or by adhesive bonding or other materially joined connection methods.

Besides the exemplary embodiments described, it is understood that still other modifications are possible within the scope of the present invention.

We claim:

1. A scanning unit comprising:
a radiation source that emits electromagnetic radiation, which is used to scan a scale of a position measuring system, wherein said radiation source comprises electrical connection elements;
a holder upon which said radiation source is fixable, wherein said holder comprises electrical conductor elements that electrically contact said electrical connection elements;
wherein said electrical conductor elements of said holder and said electrical connection elements of said radiation source form a guide on which said radiation source is movable along an adjustment path relative to said holder while maintaining electrical contact between said electrical connection elements and said electrical conductor elements in order to enable positioning said radiation source at various positions along said adjustment path on said holder wherein said electrical connection elements are in electrical contact with said electrical conductor elements.

2. The scanning unit according to claim 1, wherein said guide comprises a conductor track and an associated electrical contact element, which are displaceable relative to one another along said adjustment path so as to be in electrical contact with one another causing said radiation source to be electrically contacted at various relative positions with regard to said holder.

3. The scanning unit according to claim 2, wherein said guide comprises:
a second conductor track, wherein said conductor track and said second conductor track extend along said adjustment path; and
a second electrical contact element associated with said second conductor track.

4. The scanning unit according to claim 2, wherein said conductor track is provided as one of said electrical conductor elements on said holder and said respective associated electrical contact element is provided as one of said electrical connection elements on said radiation source.

5. The scanning unit according to claim 3, wherein said conductor track is provided as one of said electrical conductor elements on said holder and said respective associated electrical contact element is provided as one of said electrical connection elements on said radiation source; and
wherein said second conductor track is provided as one of said electrical conductor elements on said holder and said respective associated second electrical contact element is provided as one of said electrical connection elements on said radiation source.

6. The scanning unit according to claim 1, wherein said guide is embodied for a rectilinearly guided movement of said radiation source.

7. The scanning unit according to claim 6, wherein connection portions of said electrical conductor elements serve to electrically contact said radiation source, and said connection portions extend rectilinearly.

8. The scanning unit according to claim 6, wherein connection portions of said electrical conductor elements serve to electrically contact said radiation source, and said respective electrical connection elements extend rectilinearly.

9. The scanning unit according to claim 6, wherein connection portions of said electrical conductor elements serve to electrically contact said radiation source, and each of said connection portions and said respective electrical connection elements extend rectilinearly.

10. The scanning unit according to claim 1, wherein at least one of said electrical connection elements of said radiation source is formed by a contact pin protruding from said radiation source.

11. The scanning unit according to claim 1, wherein at least one of said electrical connection elements of said radiation source is embodied on said housing of said radiation source.

12. The scanning unit according to claim 1, wherein said holder comprises a receptacle into which said radiation source is disposed and is movable along said adjustment path.

13. The scanning unit according to claim 12, wherein connection regions of said conductor elements extend alongside said receptacle, wherein said connection regions electrically contact said electrical connection elements of said radiation source.

14. The scanning unit according to claim 12, wherein connection regions of said electrical conductor elements extend in front of said receptacle, wherein said connection regions electrically contact said electrical connection elements of said radiation source.

15. The scanning unit according to claim 1, wherein said electrical connection elements are materially joined to connection regions of said electrical conductor elements on an end of said holder.

16. The scanning unit according to claim 1, wherein said holder comprises a base body that comprises electrical insulation material on which said electrical conductor elements extend as electrical conductor tracks.

17. The scanning unit according to claim 1, further comprising a lens associated with said radiation source for collimating said electromagnetic radiation emitted by said radiation source, wherein a requisite spacing between said radiation source and said lens in order to achieve said collimating is settable by moving said radiation source along said adjustment path relative to said holder.

18. A position measuring system comprising:
a scale fastened to a first object, wherein said scale comprises a graduation;
a scanning unit fastened to a second object, wherein said scanning unit comprises:
a radiation source that emits electromagnetic radiation that scans said graduation, wherein said radiation source comprises electrical connection elements;
a holder upon which said radiation source is fixable, wherein said holder comprises electrical conductor elements that electrically contact said electrical connection elements;
a detector array that receives electromagnetic radiation from said scale and generates position-dependent signals from said received electromagnetic radiation;
wherein said electrical conductor elements of said holder and said electrical connection elements of said radiation source form a guide on which said radiation source is movable along an adjustment path relative to said holder while maintaining electrical contact between said electrical connection elements and said electrical conductor elements in order to enable positioning said radiation source at various positions along said adjustment path on said holder wherein said electrical connection elements are in electrical contact with said electrical conductor elements.

19. The position measuring system according to claim 18, wherein said guide comprises a conductor track and an associated electrical contact element, which are displaceable relative to one another along said adjustment path so as to be in electrical contact with one another causing said radiation source to be electrically contacted at various relative positions with regard to said holder.

20. The position measuring system according to claim 19, wherein said conductor track is provided as one of said electrical conductor elements on said holder and said respective associated electrical contact element is provided as one of said electrical connection elements on said radiation source.

21. The position measuring system according to claim 18, wherein said holder comprises a receptacle into which said radiation source is disposed and is movable along said adjustment path.

22. The position measuring system according to claim 21, wherein connection regions of said electrical conductor elements extend alongside said receptacle, wherein said connection regions electrically contact said electrical connection elements of said radiation source.

23. The position measuring system according to claim 21, wherein connection regions of said electrical conductor elements extend in front of said receptacle, wherein said connection regions electrically contact said electrical connection elements of said radiation source.

24. The position measuring system according to claim 18, further comprising a lens associated with said radiation source for collimating said electromagnetic radiation emitted by said radiation source and directing said collimated electromagnetic radiation to said graduation, wherein a requisite spacing between said radiation source and said lens in order to achieve said collimating is settable by moving said radiation source along said adjustment path relative to said holder.

25. A method of adjusting a radiation source of a position measuring system, the method comprising:
providing a radiation source at a first position, wherein said radiation source emits electromagnetic radiation and comprises electrical connection elements that electrically contact electrical conductor elements; and
moving said radiation source at a second position, wherein during said moving said electrical connection elements move relative to said electrical conductor elements and maintain electrical contact with said electrical conductor elements during said moving.

26. The method of claim 25, wherein when said radiation source is at said second position after said moving, said radiation source emits said electromagnetic radiation toward a graduation so as to scan said graduation;
said method further comprising:
generating position-dependent signals from said electromagnetic radiation after scanning said graduation.

27. The method of claim 25, wherein when said radiation source is at said second position after said moving, said radiation source emits said electromagnetic radiation toward a graduation so as to scan said graduation;
said method further comprising:
providing a lens associated with said radiation source for collimating said electromagnetic radiation emitted by said radiation source and directing said collimated electromagnetic radiation to said graduation;
setting a requisite spacing between said radiation source and said lens in order to achieve said collimating is settable by moving said radiation source from said first position to said second position; and
generating position-dependent signals from said electromagnetic radiation after scanning said graduation.
